(19) United States
(12) Patent Application Publication
(10) Pub. No.: US 2023/0251374 A1
(43) Pub. Date: Aug. 10, 2023

(54) OBJECT DETECTION APPARATUS AND OBJECT DETECTION METHOD

(71) Applicant: AISIN CORPORATION, Kariya (JP)

(72) Inventor: Kosuke TSUKAO, Kariya-shi (JP)

(73) Assignee: AISIN CORPORATION, Kariya (JP)

(21) Appl. No.: 18/153,053

(22) Filed: Jan. 11, 2023

(30) Foreign Application Priority Data
Feb. 4, 2022 (JP) 2022-016153

(51) Int. Cl. G01S 15/46; B60J 5/04; G01S 7/295

(52) U.S. Cl. CPC G01S 15/46; B60J 5/0431; G01S 7/2955

(57) ABSTRACT

An object detection apparatus includes a first and second transmission and reception units which are away from each other and transmit a probe wave and receive the probe wave reflected by an object, and a processing unit configured to calculate a position of the object based on a reception result. The processing unit includes a distance processing unit configured to calculate a first point based on a reception result when the first transmission and reception unit transmits the probe wave, calculate a second point based on a reception result when the second transmission and reception unit transmits the probe wave, and calculate a separation distance between the first and second points, a position calculation unit configured to calculate the position of the object based on the first and second points, and a position correction unit configured to correct the position with a correction amount corresponding to the calculated position.

### CROSS REFERENCE TO RELATED APPLICATIONS

This application is based on and claims priority under 35 U.S.C. § 119 to Japanese Patent Application 2022-16153, filed on Feb. 4, 2022, the entire content of which is incorporated herein by reference.

### TECHNICAL FIELD

This disclosure relates to an object detection apparatus and an object detection method.

### BACKGROUND DISCUSSION

In the related art, there is a technique for calculating a position or the like of an object by transmitting a probe wave such as an ultrasonic wave to the object, receiving the probe wave reflected by the object, and executing various calculations.

Specifically, for example, coordinates of two points are calculated based on a trilateration method using transmission and reception results of probe waves transmitted and received by two sensors arranged by a predetermined distance from each other in a horizontal direction, and a position and a shape (a wall shape, a pole shape, or the like) of the object are determined according to a distance between the two points.

Examples of the related art include JP-2020-67431A (Reference 1).

However, in the above-described related art, accuracy of a determination result differs according to the position of the object, and there is room for improvement.

A need thus exists for an object detection apparatus and an object detection method which are not susceptible to the drawback mentioned above.

### SUMMARY

According to an aspect of this disclosure, an object detection apparatus includes, for example, a first transmission and reception unit and a second transmission and reception unit which are away from each other by a predetermined distance in a horizontal direction and transmit a probe wave and receive the probe wave reflected by an object, and a processing unit configured to calculate a position of the object based on a reception result received by the first transmission and reception unit and a reception result received by the second transmission and reception unit. The processing unit includes: a distance processing unit configured to calculate a first point based on a reception result received by the first transmission and reception unit and a reception result received by the second transmission and reception unit when the first transmission and reception unit transmits the probe wave, calculate a second point based on a reception result received by the first transmission and reception unit and a reception result received by the second transmission and reception unit when the second transmission and reception unit transmits the probe wave, and calculate a separation distance between the first point and the second point; a position calculation unit configured to calculate the position of the object based on the first point and the second point; and a position correction unit configured to correct the position of the object with a correction amount corresponding to the calculated position of the object to correct an error that occurs when the position of the object is calculated.

According to another aspect of this disclosure, an object detection method uses, for example, an object detection apparatus including a first transmission and reception unit and a second transmission and reception unit which are away from each other by a predetermined distance in a horizontal direction and transmit a probe wave and receive the probe wave reflected by an object. The method includes: a distance processing step of calculating a first point based on a reception result received by the first transmission and reception unit and a reception result received by the second transmission and reception unit when the first transmission and reception unit transmits the probe wave, calculating a second point based on a reception result received by the first transmission and reception unit and a reception result received by the second transmission and reception unit when the second transmission and reception unit transmits the probe wave, and calculating a separation distance between the first point and the second point; a position calculation step of calculating a position of the object based on the first point and the second point; and a position correction step of correcting the position of the object with a correction amount corresponding to the calculated position of the object to correct an error that occurs when the position of the object is calculated.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a plan view of a vehicle on which an object detection apparatus is mounted as viewed from above according to an embodiment;

FIG. 2 is a block diagram illustrating a hardware configuration of the object detection apparatus according to the embodiment;

FIG. 3 is a block diagram illustrating functions of the object detection apparatus according to the embodiment;

FIG. 4 is a diagram illustrating a functional outline of a plurality of transmission and reception units according to the embodiment;

FIGS. 5A and 5B are schematic diagrams illustrating states in which the plurality of transmission and reception units perform transmission and reception according to the embodiment;

FIG. 6 is a schematic diagram illustrating a state in which an object is determined by an object detection unit according to the embodiment;

FIGS. 7A and 7B are schematic diagrams illustrating states in which the plurality of transmission and reception units perform transmission and reception according to the embodiment;

FIG. 8 is a schematic diagram illustrating a state in which the object is determined by the object detection unit according to the embodiment;

FIGS. 9A and 9B are schematic diagrams illustrating states in which the plurality of transmission and reception units perform transmission and reception according to the embodiment;

FIG. 10 is a schematic diagram illustrating a state in which the object is determined by the object detection unit according to the embodiment;

FIGS. 11A and 11B are schematic diagrams illustrating states in which a collision position between the object and a door is determined by the object detection unit according to the embodiment;

FIGS. 12A and 12B are schematic diagrams illustrating states in which a collision position between the object and the door is determined by the object detection unit according to the embodiment;

FIGS. 13A and 13B are schematic diagrams illustrating states in which a collision position between the object and the door is determined by the object detection unit according to the embodiment;

FIG. 14 is a diagram illustrating a relationship between a distance from a sensor to an object and a detection error according to the embodiment;

FIGS. 15A and 15B are diagrams illustrating a relationship between a distance from a hinge of a door to an object and a degree of influence on a door opening degree limitation due to a detection error according to the embodiment;

FIGS. 16A and 16B are diagrams illustrating an example of object detection according to the embodiment;

FIG. 17 is a diagram illustrating an example of the object detection according to the embodiment; and

FIG. 18 is a flowchart illustrating object detection processing performed by the object detection apparatus according to the embodiment.

### DETAILED DESCRIPTION

Hereinafter, an exemplary embodiment of this disclosure will be disclosed. Configurations of the embodiment described below and operations, results, and effects provided by the configurations are examples. This disclosure can also be implemented by configurations other than those disclosed in the following embodiment, and at least one of various effects and derivative effects based on a basic configuration can be obtained. In the following description, for convenience of description, an elliptical arc is expressed as an “arc”.

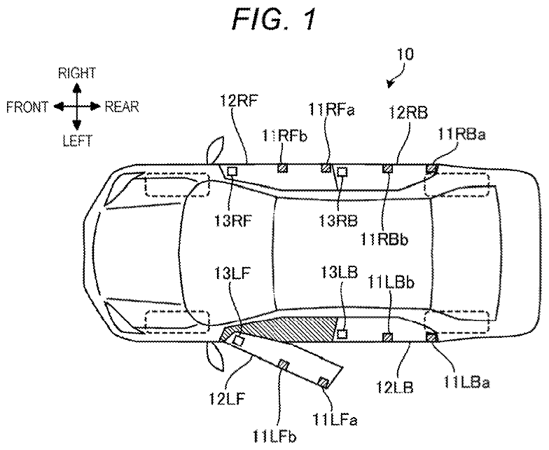

FIG. 1 is a plan view of a vehicle 10 on which an object detection apparatus is mounted as viewed from above according to the embodiment. Directions indicated by arrows in an upper left part of FIG. 1 are front-rear and left-right directions of the vehicle 10.

As illustrated in FIG. 1, in the vehicle 10 on which the object detection apparatus is mounted, a plurality of transmission and reception units 11RFa, 11RFb, 11RBa, 11RBb, 11LFa, 11LFb, 11LBa, and 11LBb included in the object detection apparatus are provided on, for example, decorative plates of doors 12RF, 12RB, 12LF, and 12LB (examples of a door that is opened and closed by rotating about a hinge as a shaft) of the vehicle 10.

The transmission and reception unit 11RFa is provided, for example, in the vicinity of an end portion on an opening and closing end side of the right front door 12RF. A vertical position of the transmission and reception unit 11RFa can be set to a lower position of the door 12RF by fitting the transmission and reception unit 11RFa into a decorative plate at a lower portion of the door 12RF. Alternatively, the vertical position of the transmission and reception unit 11RFa can also be set to a central position with respect to upper and lower ends of the door 12RF, a position protruding to an outermost side of the door 12RF, or the like. The transmission and reception unit 11RFb is provided, for example, closer to the front of the vehicle 10 than the transmission and reception unit 11RFa of the door 12RF, and is away from the transmission and reception unit 11RFa by a predetermined distance. A vertical position of the transmission and reception unit 11RFb is the same as, for example, the vertical position of the transmission and reception unit 11RFa. That is, the transmission and reception unit 11RFb (an example of a first transmission and reception unit) and the transmission and reception unit 11RFa (an example of a second transmission and reception unit) are away from each other by the predetermined distance in a horizontal direction. The transmission and reception units 11LFa and 11LFb are provided, for example, at positions of the left front door 12LF to correspond to the transmission and reception units 11RFa and 11RFb respectively.

The transmission and reception unit 11RBa is provided, for example, in the vicinity of an end portion on an opening and closing end side of the right rear door 12RB. A vertical position of the transmission and reception unit 11RBa can be set to a lower position of the door 12RB by fitting the transmission and reception unit 11RBa into a decorative plate at a lower portion of the door 12RB. Alternatively, the vertical position of the transmission and reception unit 11RBa can also be set to a center position with respect to upper and lower ends of the door 12RB, a position protruding to an outermost side of the door 12RB, or the like. The transmission and reception unit 11RBb is provided, for example, closer to the front of the vehicle 10 than the transmission and reception unit 11RBa of the door 12RB, and is away from the transmission and reception unit 11RBa by a predetermined distance. A vertical position of the transmission and reception unit 11RBb is the same as, for example, the vertical position of the transmission and reception unit 11RBa. That is, the transmission and reception unit 11RBb and the transmission and reception unit 11RBa are away from each other by the predetermined distance in the horizontal direction. The transmission and reception units 11LBa and 11LBb are provided, for example, at positions of the left rear door 12LB to correspond to the transmission and reception units 11RBa and 11RBb respectively.

Hereinafter, each of the plurality of transmission and reception units 11RFa, 11RFb, 11RBa, 11RBb, 11LFa, 11LFb, 11LBa, and 11LBb are simply referred to as a transmission and reception unit 11 or the like when not particularly distinguished from each other. In addition, each of the plurality of doors 12RF, 12RB, 12LF, and 12LB are simply referred to as a door 12 or the like when not particularly distinguished from each other.

The transmission and reception unit 11 is a sensor or a sonar that transmits a probe wave such as an ultrasonic wave. The transmission and reception unit 11 also functions as a receiver that receives the probe wave reflected by an object. The transmission and reception unit 11 transmits and receives the probe wave to and from the vicinity of door 12 to detect the object present in the vicinity of the door 12.

In the vehicle 10 on which the object detection apparatus is mounted, a plurality of door opening degree adjustment units 13RF, 13RB, 13LF, and 13LB included in the object detection apparatus are also provided, for example, inside outer panels of the doors 12RF, 12RB, 12LF, and 12LB of the vehicle 10 respectively.

The door opening degree adjustment unit 13RF is provided, for example, in the vicinity of an end portion on a hinge side of the right front door 12RF. The door opening degree adjustment unit 13RB is provided, for example, in the vicinity of an end portion on a hinge side of the right rear door 12RB. The door opening degree adjustment unit 13LF is provided, for example, in the vicinity of an end portion on a hinge side of the left front door 12LF. The door opening degree adjustment unit 13LB is provided, for example, in the vicinity of an end portion on a hinge side of the left rear door 12LB.

Hereinafter, each of the plurality of door opening degree adjustment units 13RF, 13RB, 13LF, and 13LB will be simply referred to as a door opening degree adjustment unit 13 or the like when not particularly distinguished from each other.

When an object that may be an obstacle is present in the vicinity of any of the doors 12, the door opening degree adjustment unit 13 adjusts an opening degree of the door 12 to avoid a collision between the door 12 and the object.

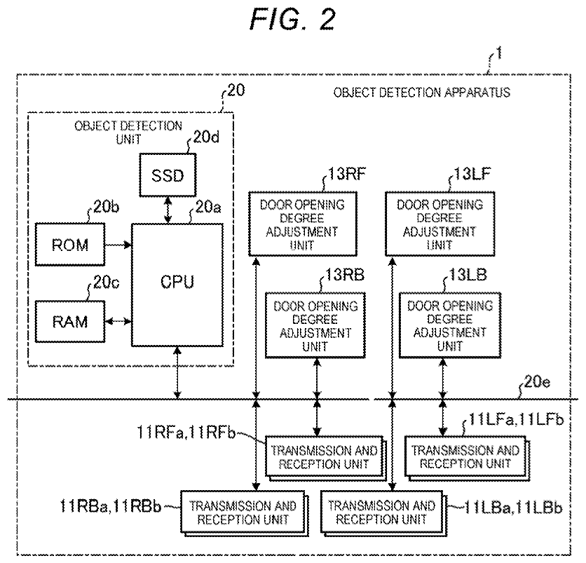

FIG. 2 is a block diagram illustrating a hardware configuration of an object detection apparatus 1 according to the embodiment. The object detection apparatus 1 detects the object in the vicinity of the doors 12 of the vehicle 10 based on reception results received by the transmission and reception units 11 or the like. When the object that may be an obstacle is detected, the object detection apparatus 1 avoids the collision with the object using the door opening degree adjustment unit 13.

As illustrated in FIG. 2, the object detection apparatus 1 includes the plurality of transmission and reception units 11RFa, 11RFb, 11RBa, 11RBb, 11LFa, 11LFb, 11LBa, and 11LBb, the plurality of door opening degree adjustment units 13RF, 13RB, 13LF, and 13LB, an object detection unit 20, and an in-vehicle network 20e.

The plurality of transmission and reception units 11 are connected to the in-vehicle network 20e and transmit transmission and reception information to the object detection unit 20 via the in-vehicle network 20e. A plurality of door opening degree adjustment units 13 are connected to the in-vehicle network 20e and are controlled by the object detection unit 20 via the in-vehicle network 20e to adjust opening degrees of the doors 12.

The object detection unit 20 determines presence of the object and a position of the object based on the transmission and reception information acquired from the plurality of transmission and reception units 11. The object detection unit 20 outputs information on the detected object to the door opening degree adjustment units 13 to prevent the collision with the doors 12.

The object detection unit 20 is a computer including a microcomputer such as an electronic control unit (ECU). The object detection unit 20 includes a central processing unit (CPU) 20a, a read only memory (ROM) 20b, a random access memory (RAM) 20c, and a solid state drive (SSD) 20d. The CPU 20a, the ROM 20b, and the RAM 20c may be integrated in the same package.

The CPU 20a is an example of a hardware processor, reads a program stored in a non-volatile storage device such as the ROM 20b, and executes various calculation processing and control according to the program.

The ROM 20b stores programs, parameters necessary for executing the programs, and the like. The RAM 20c temporarily stores various data used in the calculation executed by the CPU 20a. The SSD 20d is a rewritable non-volatile storage device and maintains data even when a power supply of the object detection unit 20 is turned off.

The in-vehicle network 20e is, for example, a controller area network (CAN). The in-vehicle network 20e electrically connects the plurality of transmission and reception units 11, the plurality of door opening degree adjustment units 13, and the object detection unit 20 so as to be able to transmit and receive signals and information to and from each other.

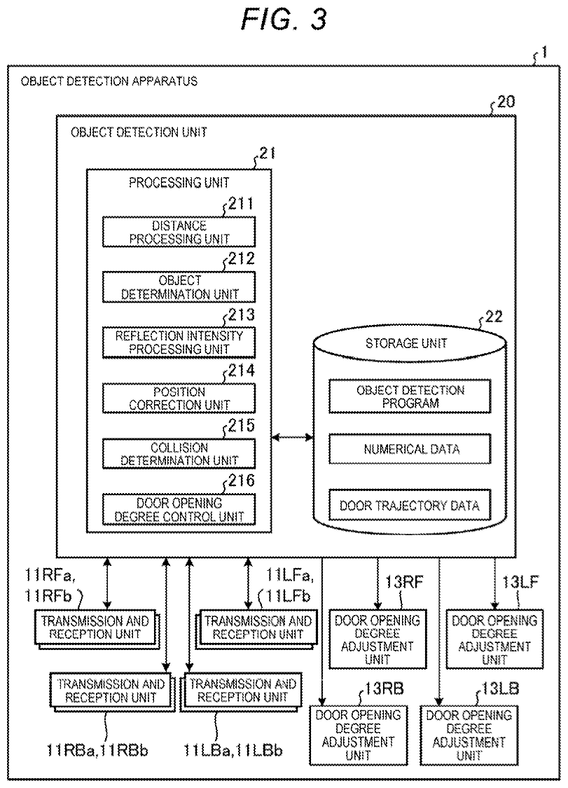

FIG. 3 is a block diagram illustrating functions of the object detection apparatus 1 according to the embodiment. As illustrated in FIG. 3, the object detection unit 20 of the object detection apparatus 1 includes a processing unit 21 and a storage unit 22.

The storage unit 22 stores a program executed by the processing unit 21 and data necessary for executing the program. For example, the storage unit 22 stores an object detection program executed by the processing unit 21. The storage unit 22 stores numerical data necessary for executing the object detection program. In addition, the storage unit 22 stores door trajectory data necessary for executing the object detection program.

The processing unit 21 calculates the position of the object based on the reception results received by the plurality of transmission and reception units 11. The processing unit 21 is implemented, for example, as a function of the CPU 20a. The processing unit 21 includes a distance processing unit 211, an object determination unit 212, a reflection intensity processing unit 213, a position correction unit 214, a collision determination unit 215, and a door opening degree control unit 216. The processing unit 21 functions as the units 211 to 216 by, for example, reading the object detection program stored in the storage unit 22. A part or all of the units 211 to 216 may be implemented by hardware such as a circuit including an application specific integrated circuit (ASIC) or a field-programmable gate array (FPGA).

Hereinafter, when examples are provided, the transmission and reception units 11RFa and 11RFb are mainly taken as examples of the plurality of transmission and reception units 11, and the same applies to other transmission and reception units 11.

The distance processing unit 211 calculates a first point based on a reception result received by the transmission and reception unit 11RFa and a reception result received by the transmission and reception unit 11RFb when the transmission and reception unit 11RFa transmits a probe wave, and calculates a second point based on a reception result received by the transmission and reception unit 11RFa and a reception result received by the transmission and reception unit 11RFb when the transmission and reception unit 11RFb transmits a probe wave. The distance processing unit 211 calculates a separation distance between the first point and the second point. Further, the distance processing unit 211 determines whether the separation distance is equal to or greater than a predetermined separation distance threshold.

The object determination unit 212 (an example of a position calculation unit and a shape determination unit) determines the position, an outer shape, and the like of the object based on information calculated by the distance processing unit 211. For example, the object determination unit 212 calculates the position of the object based on the first point and the second point. The object determination unit 212 determines whether the object has a wall shape or a pole shape according to the separation distance.

The reflection intensity processing unit 213 calculates a reflection intensity representing an intensity of probe waves received by the transmission and reception unit 11RFa and the transmission and reception unit 11RFb. The reflection intensity processing unit 213 determines whether the reflection intensity is equal to or greater than a predetermined reflection intensity threshold.

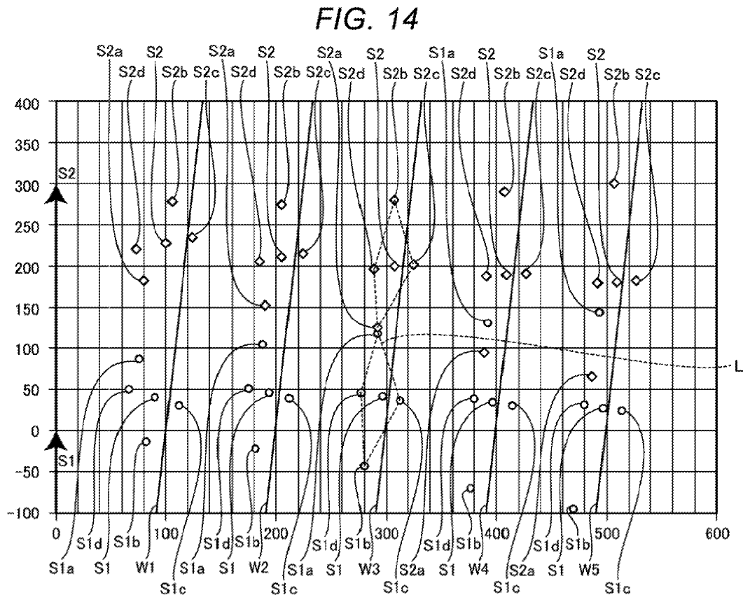

The position correction unit 214 corrects the position of the object with a correction amount according to the calculated position of the object. The position correction unit 214 sets the correction amount to be larger, for example, as the calculated position of the object is closer to positions of the transmission and reception unit 11RFb and the transmission and reception unit 11RFa (for example, an intermediate position therebetween) (to be described in detail in FIG. 14 later).

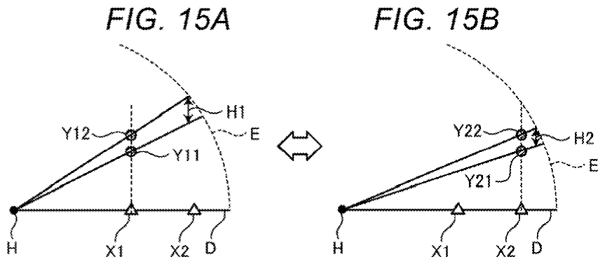

In addition, the position correction unit 214 sets the correction amount to be larger, for example, as the calculated position of the object is closer to a position of the hinge of the door 12 (to be described in detail in FIGS. 15A and 15B later).

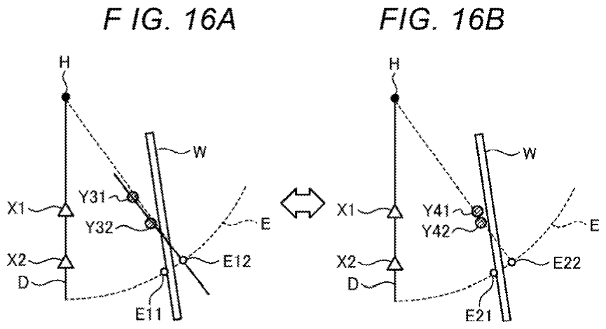

Further, the position correction unit 214 sets the correction amount to be larger, for example, when the object determination unit 212 determines that the object has a pole shape and the reflection intensity calculated by the reflection intensity processing unit 213 exceeds the predetermined reflection intensity threshold than when the reflection intensity does not exceed the predetermined reflection intensity threshold (to be described in detail in FIG. 16 later).

In addition, the position correction unit 214 sets the correction amount to be larger, for example, when at least one of the probe waves transmitted by the transmission and reception unit 11RFb and the transmission and reception unit 11RFa is not received by the transmission and reception unit 11RFb or the transmission and reception unit 11RFa than when all of the probe waves are received.

When the object that may be an obstacle is detected in the vicinity of any of the doors 12, the collision determination unit 215 determines whether a collision may occur between the door 12 and the object when the door 12 is opened. For example, the collision determination unit 215 determines whether the object is present in a region surrounded by a fully closed position of the door 12, a fully opened position of the door 12, and a trajectory during opening and closing of the door 12, and calculates a collision position between the object and the door 12 when the object is present in the region.

When the collision position between the door 12 and the object is calculated by the collision determination unit 215, the door opening degree control unit 216 controls the door opening degree adjustment unit 13 to limit the opening degree of the door 12 based on the collision position such that the door 12 is stopped right before the collision position.

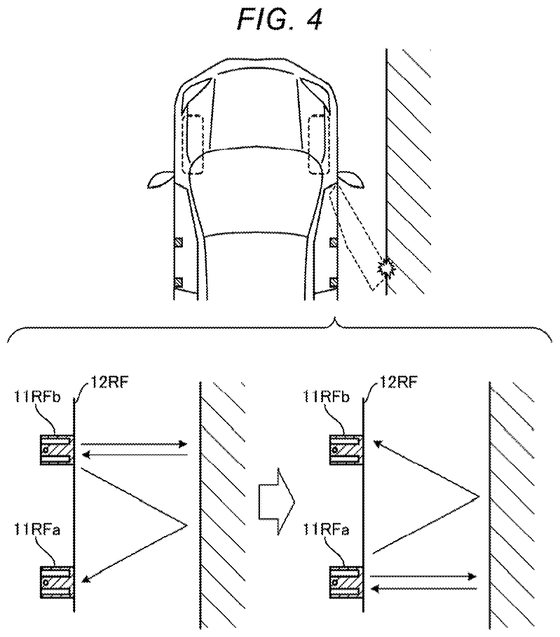

Next, a method for detecting an object using the object detection apparatus 1 will be described in detail with reference to FIG. 4 and subsequent drawings. FIG. 4 is a diagram illustrating a functional outline of the plurality of transmission and reception units 11 according to the embodiment. As illustrated in FIG. 4, each of the plurality of transmission and reception units 11 radially transmits the probe wave toward the outside of the door 12 and receives the probe wave toward the transmission and reception unit itself. At this time, among the plurality of transmission and reception units 11, transmission and reception units 11 provided on the same door 12 are interlocked with each other as a pair. For example, the two transmission and reception units 11RFa and 11RFb provided on the door 12RF illustrated in FIG. 4 operate in cooperation with each other. Accordingly, an object in the vicinity of the door 12RF is detected, and a collision with the object is avoided.

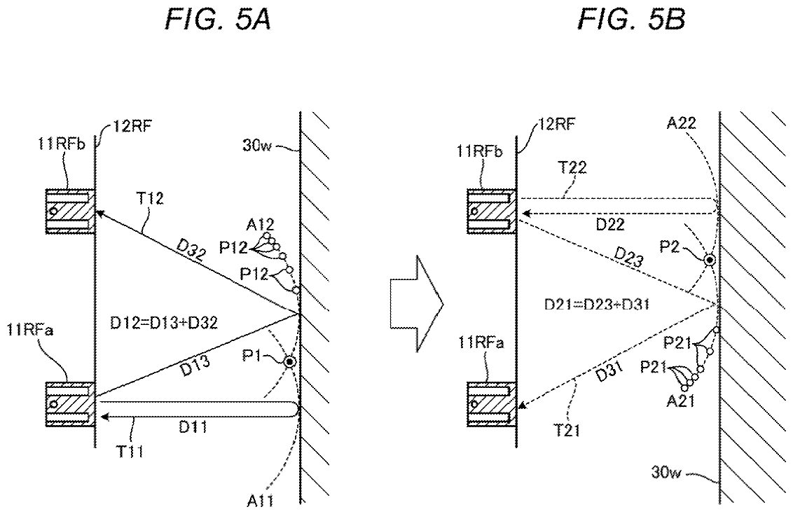

Specifically, the transmission and reception units 11RFa and 11RFb alternately repeat a period in which each of the transmission and reception units 11RFa and 11RFb transmits and receives the probe wave and a period in which each of the transmission and reception units 11RFa and 11RFb only receives the probe wave. At this time, the transmission and reception unit 11RFa transmits and receives the probe wave during a period in which the transmission and reception unit 11RFb receives the probe wave. In addition, the transmission and reception unit 11RFa only receives the probe wave during a period in which the transmission and reception unit 11RFb transmits and receives the probe wave. The transmission and reception unit 11RFb transmits and receives the probe wave during a period in which the transmission and reception unit 11RFa receives the probe wave. In addition, the transmission and reception unit 11RFb only receives the probe wave during a period in which the transmission and reception unit 11RFa transmits and receives the probe wave. These states are illustrated in FIGS. 5A and 5B.

FIGS. 5A and 5B are schematic diagrams illustrating states in which the plurality of transmission and reception units 11RFa and 11RFb perform transmission and reception according to the embodiment. In FIGS. 5A and 5B, an object 30w such as a wall is present in the vicinity of the door 12RF and is parallel to the door 12RF.

FIG. 5A illustrates a state in which the transmission and reception unit 11RFa performs transmission and reception and the transmission and reception unit 11RFb only performs reception. During this period, the transmission and reception units 11RFa and 11RFb receive various probe waves reflected by the surrounding object 30w or the like. When receiving information of the various probe waves as the transmission and reception information, the distance processing unit 211 of the processing unit 21 included in the object detection unit 20 determines that certain object 30w is present in the vicinity of the door 12RF. Then, the distance processing unit 211 extracts the probe waves first received by the transmission and reception units 11RFa and 11RFb from the various received probe waves.

As illustrated in FIG. 5A, the transmission and reception unit 11RFa first receives a probe wave T11 which is transmitted toward a position closest to the transmission and reception unit 11RFa in the wall-shaped object 30w and reflected toward the transmission and reception unit 11RFa. The distance processing unit 211 obtains a distance D11 between the transmission and reception unit 11RFa and the object 30w based on the detected probe wave T11. The distance D11 is a value half of a numerical value obtained by multiplying a time, by a sound velocity, from the transmission of the probe wave to the reception of the probe wave T11 by the transmission and reception unit 11RFa. However, with only such information, a direction in which the object 30w is present cannot be identified. Therefore, the object determination unit 212 calculates a virtual arc A11 away from the transmission and reception unit 11RFa by the distance D11, and assumes that the object 30w is present at least at any position on the arc A11.

The transmission and reception unit 11RFb first receives a probe wave T12, which reaches the transmission and reception unit 11RFb through a shortest path among paths from the transmission and reception unit 11RFa to the transmission and reception unit 11RFb via the object 30w. Based on the detected probe wave T12, the distance processing unit 211 obtains a length of two sides of a triangle having the transmission and reception units 11RFa and 11RFb as two vertices and having a third vertex on the object 30w, that is, a shortest distance D12=D13+D32 between the transmission and reception units 11RFa and 11RFb via the object 30w. The length (D13+D32) of the two sides is a value obtained by multiplying a time, by the sound velocity, from when the transmission and reception unit 11RFa transmits the probe wave to when the transmission and reception unit 11RFb receives the probe wave T12. Next, the distance processing unit 211 calculates a position of the third vertex of the triangle having the transmission and reception units 11RFa and 11RFb as the two vertices. Given that a length of a side between the transmission and reception units 11RFa and 11RFb is known, the position of the third vertex can be obtained using a trilateration method based on the length of the two sides D13 and D32. However, individual lengths D13 and D32 of the two sides are not known, and thus the third vertex cannot be identified as being located at one position with only such information. That is, there are a plurality of triangles each having the obtained length (D13+D32) of the two sides and having the third vertex at a different position. Therefore, the object determination unit 212 calculates a virtual arc A12 connecting vertices P12 of the plurality of triangles, and assumes that the object 30w is present at least at any position on the arc A12.

Further, the object determination unit 212 estimates that the object 30w is present at a point P1 (first point) which is an intersection point of the calculated two arcs A11 and A12. However, the point P1 is located slightly before (closer to the door 12RF) a position at which the object 30w is actually present.

FIG. 5B illustrates a state in which the transmission and reception unit 11RFb performs transmission and reception and the transmission and reception unit 11RFa only performs reception. During this period, the transmission and reception units 11RFa and 11RFb receive various probe waves reflected by the surrounding object 30w or the like. The distance processing unit 211 receives the information of the various probe waves as the transmission and reception information, and extracts the probe waves first received by the transmission and reception units 11RFa and 11RFb from the various received probe waves.

As illustrated in FIG. 5B, the transmission and reception unit 11RFa first receives a probe wave T21, which reaches the transmission and reception unit 11RFa through a shortest path among paths from the transmission and reception unit 11RFb to the transmission and reception unit 11RFa via the object 30w. Based on the detected probe wave T21, the distance processing unit 211 obtains a length of two sides of a triangle having the transmission and reception units 11RFa and 11RFb as two vertices and having a third vertex on the object 30w, that is, a shortest distance D21=D23+D31 between the transmission and reception units 11RFa and 11RFb via the object 30w. The length (D23+D31) of the two sides is a value obtained by multiplying a time, by the sound velocity, from when the transmission and reception unit 11RFb transmits the probe wave T21 to when the transmission and reception unit 11RFa receives the probe wave T21. Next, the distance processing unit 211 calculates a position of the third vertex of the triangle having the transmission and reception units 11RFa and 11RFb as the two vertices. The position of the third vertex can be obtained using the trilateration method base on the length of the two sides D23 and D31 given that a length of the side between the transmission and reception units 11RFa and 11RFb is known. However, individual lengths D23 and D31 of the two sides are not known, and thus the position of the third vertex cannot be identified as one with only such information. That is, there are a plurality of triangles each having the obtained length (D23+D31) of the two sides and having the third vertex at a different position. Therefore, the object determination unit 212 calculates a virtual arc A21 connecting vertices P21 of the plurality of triangles, and assumes that the object 30w is present at least at any position on the arc A21.

As illustrated in FIG. 5B, the transmission and reception unit 11RFb first receives a probe wave T22, which is transmitted toward a position closest to the transmission and reception unit 11RFb in the wall-shaped object 30w and reflected toward the transmission and reception unit 11RFb. The distance processing unit 211 obtains a distance D22 between the transmission and reception unit 11RFb and the object 30w based on the detected probe wave T22. The distance D22 is a value half of a numerical value obtained by multiplying a time, by the sound velocity, from the transmission of the probe wave T22 to the reception of the probe wave T22 by the transmission and reception unit 11RFb. However, with only such information, a direction in which the object 30w is present cannot be identified. Therefore, the object determination unit 212 calculates a virtual arc A22 away from the transmission and reception unit 11RFb by the distance D22, and assumes that the object 30w is present at least at any position on the arc A22.

Further, the object determination unit 212 estimates that the object 30w is present at a point P2 (second point) which is an intersection point of the calculated two arcs A21 and A22. However, the point P2 is located slightly before (closer to the door 12RF) the position at which the object 30w is actually present.

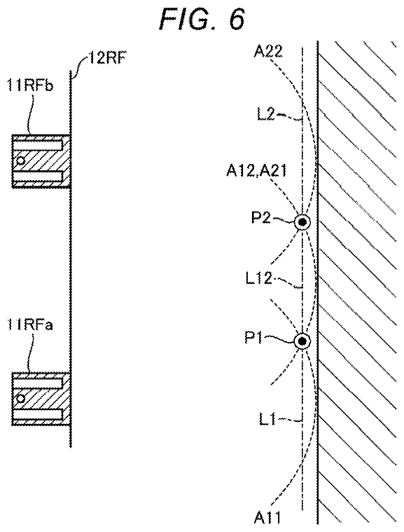

As described above, the two points P1 and P2 are obtained as positions at which the object 30w is present. When a separation distance between the points P1 and P2 is equal to or greater than a predetermined value, that is, when the points P1 and P2 are sufficiently away from each other, it is understood that the object 30w is an object such as a wall extending in a wide range to some extent. This state is illustrated in FIG. 6.

FIG. 6 is a schematic diagram illustrating a state in which the object 30w is determined by the object detection unit 20 according to the embodiment. As illustrated in FIG. 6, the distance processing unit 211 determines whether the separation distance between the points P1 and P2 is equal to or greater than the predetermined value (the predetermined separation distance threshold) based on the obtained points P1 and P2. The predetermined value is, for example, a threshold or the like in the numerical data stored in the storage unit 22. When the separation distance between the points P1 and P2 is equal to or greater than the predetermined value, the object determination unit 212 determines that the object 30w is present in parallel with the door 12RF with a certain degree of extension on a line segment L12 connecting the points P1 and P2 and line segments L1 and L2 obtained by extending both ends of the line segment L12.

Next, a case in which the wall-shaped object is present in an inclined manner with respect to the door 12RF will be described.

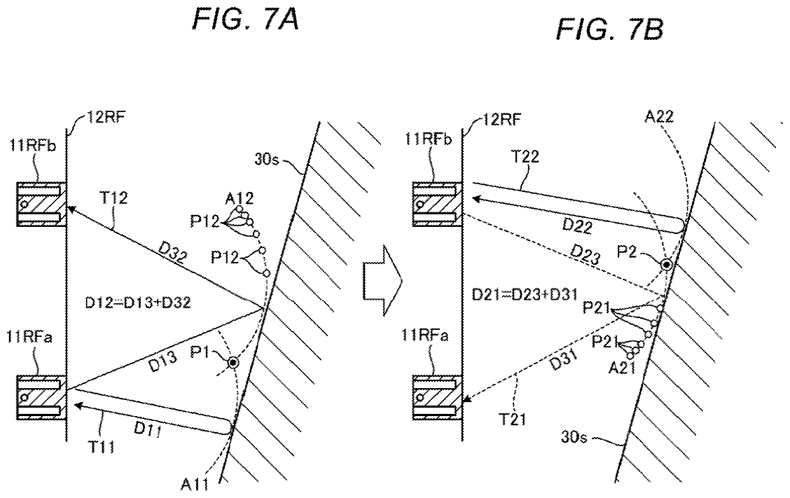

FIGS. 7A and 7B are schematic diagrams illustrating states in which the plurality of transmission and reception units 11RFa and 11RFb perform transmission and reception according to the embodiment. In FIGS. 7A and 7B, an object 30s such as a wall is present in the vicinity of the door 12RF and inclined with respect to the door 12RF.

FIG. 7A illustrates the state in which the transmission and reception unit 11RFa performs the transmission and reception and the transmission and reception unit 11RFb only performs the reception. The distance processing unit 211 extracts the probe waves first received by the transmission and reception units 11RFa and 11RFb.

As illustrated in FIG. 7A, the transmission and reception unit 11RFa first receives the probe wave T11, which passes through a shortest path between the transmission and reception unit 11RFa and the object 30s. The distance processing unit 211 obtains the distance D11 between the transmission and reception unit 11RFa and the object 30s based on the detected probe wave T11. Then, the object determination unit 212 calculates the virtual arc A11 away from the transmission and reception unit 11RFa by the distance D11.

The transmission and reception unit 11RFb first receives the probe wave T12, which passes through a shortest path from the transmission and reception unit 11RFa to the transmission and reception unit 11RFb via the object 30s. Based on the detected probe wave T12, the distance processing unit 211 obtains the length (D12=D13+D32) of two sides of a triangle having the transmission and reception units 11RFa and 11RFb as two vertices and having a third vertex on the object 30s. Then, the object determination unit 212 calculates the virtual arc A12 connecting the plurality of vertices P12 based on the obtained other vertices of a plurality of triangles using the trilateration method.

Further, the object determination unit 212 estimates that the object 30s is present at the point P1 which is the intersection point of the calculated two arcs A11 and A12. However, the point P1 is located slightly before (closer to the door 12RF) a position at which the object 30s is actually present.

FIG. 7B illustrates the state in which the transmission and reception unit 11RFb performs the transmission and reception and the transmission and reception unit 11RFa only performs the reception. The distance processing unit 211 extracts the probe waves first received by the transmission and reception units 11RFa and 11RFb.

As illustrated in FIG. 7B, the transmission and reception unit 11RFa first receives the probe wave T21, which passes through a shortest path from the transmission and reception unit 11RFb to the transmission and reception unit 11RFa via the object 30s. Based on the detected probe wave T21, the distance processing unit 211 obtains the length (D21=D23+D31) of two sides of a triangle having the transmission and reception units 11RFa and 11RFb as two vertices and having a third vertex on the object 30s. Then, the object determination unit 212 calculates the virtual arc A21 connecting the plurality of vertices P21 based on the obtained other vertices of a plurality of triangles using the trilateration method.

The transmission and reception unit 11RFb first receives the probe wave T22, which passes through a shortest path between the transmission and reception unit 11RFb and the object 30s. The distance processing unit 211 obtains the distance D22 between the transmission and reception unit 11RFb and the object 30s based on the detected probe wave T22. Then, the object determination unit 212 calculates the virtual arc A22 away from the transmission and reception unit 11RFb by the distance D22.

Further, the object determination unit 212 estimates that the object 30s is present at the point P2 which is the intersection point of the calculated two arcs A21 and A22. However, the point P2 is located slightly before (closer to the door 12RF) the position at which the object 30s is actually present.

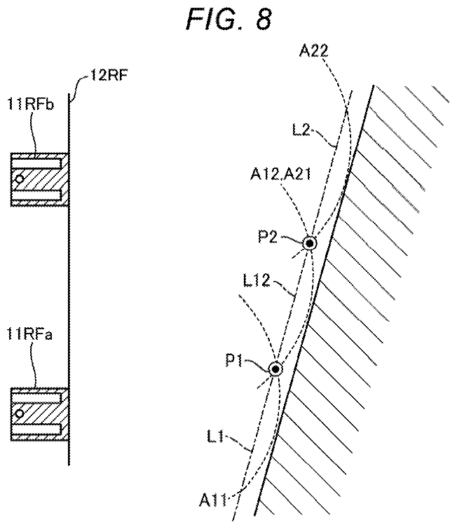

FIG. 8 is a schematic diagram illustrating a state in which the object 30s is determined by the object detection unit 20 according to the embodiment. When a separation distance between the obtained points P1 and P2 is equal to or greater than a predetermined value, the object determination unit 212 of the object detection unit 20 determines that the object 30s is an object such as a wall extending in a wide range to some extent. That is, as illustrated in FIG. 8, based on the obtained points P1 and P2, the object determination unit 212 determines that the object 30s is present in an inclined manner with respect to the door 12RF with a certain degree of extension on the line segment L12 connecting the points P1 and P2 and the line segments L1 and L2 obtained by extending both ends of the line segment L12.

Next, a case in which a pole-shaped object is present in the vicinity of the door 12RF will be described.

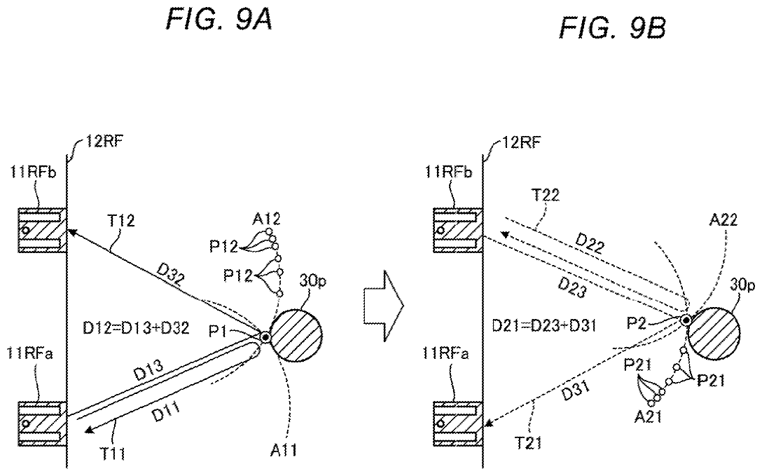

FIGS. 9A and 9B are schematic diagrams illustrating states in which the plurality of transmission and reception units 11RFa and 11RFb perform transmission and reception according to the embodiment. In FIGS. 9A and 9B, a rod-shaped object 30p such as a pole is present in the vicinity of the door 12RF.

FIG. 9A illustrates the state in which the transmission and reception unit 11RFa performs the transmission and reception and the transmission and reception unit 11RFb only performs the reception. The distance processing unit 211 extracts the probe waves T11 and T12 first received by the transmission and reception units 11RFa and 11RFb.

As illustrated in FIG. 9A, the distance processing unit 211 obtains the distance D1l between the transmission and reception unit 11RFa and the object 30p based on the detected probe wave T11. Then, the object determination unit 212 calculates the virtual arc A11 away from the transmission and reception unit 11RFa by the distance D11.

Based on the detected probe wave T12, the distance processing unit 211 obtains the length (D12=D13+D32) of two sides of a triangle having the transmission and reception units 11RFa and 11RFb as two vertices and having a third vertex on the object 30p. Then, the object determination unit 212 calculates the virtual arc A12 connecting the vertices P12 of a plurality of triangles.

Further, the object determination unit 212 estimates that the object 30p is present at the point P1 which is the intersection point of the calculated two arcs A11 and A12. However, the point P1 is located slightly before (closer to the door 12RF) a position at which the object 30p is actually present.

FIG. 9B illustrates the state in which the transmission and reception unit 11RFb performs the transmission and reception and the transmission and reception unit 11RFa only performs the reception. The distance processing unit 211 extracts the probe waves T21 and T22 first received by the transmission and reception units 11RFa and 11RFb.

As illustrated in FIG. 9B, based on the detected probe wave T21, the distance processing unit 211 obtains the length (D21=D23+D31) of two sides of a triangle having the transmission and reception units 11RFa and 11RFb as two vertices and having a third vertex on the object 30p. Then, the object determination unit 212 calculates the virtual arc A21 connecting the vertices P21 of a plurality of triangles.

Further, the distance processing unit 211 obtains the distance D22 between the transmission and reception unit 11RFb and the object 30p based on the detected probe wave T22. Then, the object determination unit 212 calculates the virtual arc A22 away from the transmission and reception unit 11RFb by the distance D22.

Further, the object determination unit 212 estimates that the object 30p is present at the point P2 which is the intersection point of the calculated two arcs A21 and A22. However, the point P2 is located slightly before (closer to the door 12RF) the position at which the object 30p is actually present.

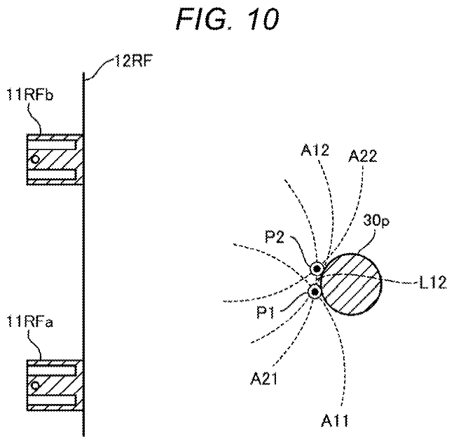

FIG. 10 is a schematic diagram illustrating a state in which the object 30p is determined by the object detection unit 20 according to the embodiment. As illustrated in FIG. 10, the separation distance between the obtained points P1 and P2 is less than a predetermined value. That is, the points P1 and P2 are fairly close to each other. Accordingly, the object determination unit 212 determines that the object 30p is a rod-shaped object limited to a certain narrow range. Specifically, based on the obtained points P1 and P2, the object determination unit 212 of the object detection unit 20 determines that the object 30p is present in a limited range on the line segment L12 connecting the points P1 and P2.

As described above with reference to FIGS. 5A to 10, the object determination unit 212 of the object detection unit 20 determines the distance from the door 12RF to the object, the direction, and the outer shape such as a wall shape or a pole shape of the object detected by the transmission and reception units 11RFa and 11RFb. The same applies to cases in which other transmission and reception units 11RBa, 11RBb, 11LFa, 11LFb, 11LBa, and 11LBb are used. The transmission and reception units 11RBa and 11RBb provided on the door 12RB operate in cooperation with each other to detect an object in the vicinity of the door 12RB. The transmission and reception units 11LFa and 11LFb provided on the door 12LF operate in cooperation with each other to detect an object in the vicinity of the door 12LF. The transmission and reception units 11LBa and 11LBb provided on the door 12LB operate in cooperation with each other to detect an object in the vicinity of the door 12LB. The object determination unit 212 determines a position, an outer shape, and the like of the object detected by each of the transmission and reception units 11.

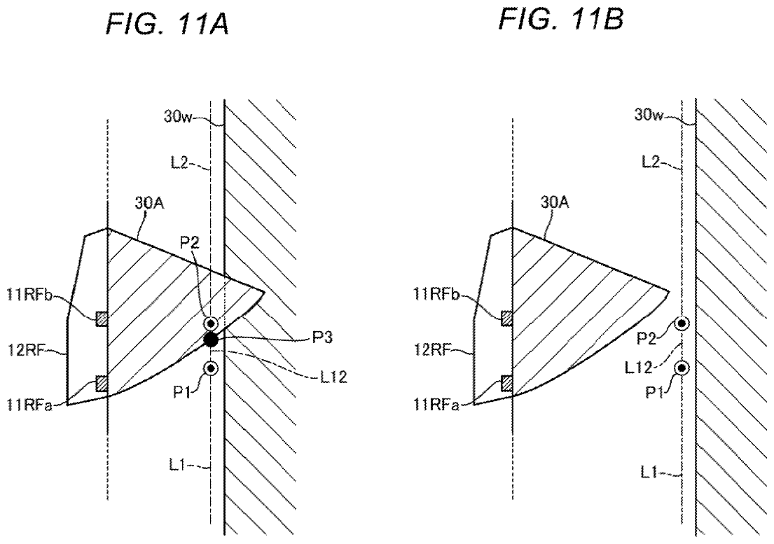

Next, a method for avoiding a collision between an object and the door 12 using the object detection apparatus 1 will be described with reference to FIGS. 11A to 13B. Hereinafter, an example in which a collision with an object, which is determined mainly based on operations of the transmission and reception units 11RFa and 11RFb, is avoided will be described, but the collision can also be avoided using the same method when other transmission and reception units 11RBa, 11RBb, 11LFa, 11LFb, 11LBa, and 11LBb are used.

As described above, when it is determined that an object that may be an obstacle is present in the vicinity of the door 12RF, the object detection apparatus 1 avoids the collision according to the outer shape of the object.

FIGS. 11A and 11B are schematic diagrams illustrating states in which a collision position between the object 30w and the door 12RF is determined by the object detection unit 20 according to the embodiment. In FIGS. 11A and 11B, it is determined that the object 30w such as a wall is present in the vicinity of the door 12RF and is parallel to the door 12RF.

As illustrated in FIGS. 11A and 11B, the collision determination unit 215 determines whether a collision may occur between the door 12RF and the object when the door 12RF is opened. When the collision may occur between the door 12RF and the object, the collision determination unit 215 calculates the collision position between the door 12RF and the object.

Specifically, the collision determination unit 215 refers to the door trajectory data stored in the storage unit 22, and determines whether the detected object 30w is present in a region 30A surrounded by a fully closed position of the door 12RF, a fully opened position of the door 12RF, and a trajectory during opening and closing of the door 12RF. When it is determined that the object 30w is a wall-shaped object, the collision determination unit 215 determines that the object 30w is present not only on the line segment L12 between the points P1 and P2 but also on the line segments L1 and L2 obtained by extending both ends of the line segment L12. Therefore, the collision determination unit 215 determines whether any one of the line segments L1, L12, and L2 that indicate presence of the object 30w is included in the region 30A.

In FIG. 11A, among the line segments L1, L12, and L2, the line segments L12 and L2 are included in the region 30A. In addition, when the door 12RF is opened from a fully closed state, a point P3 on the line segment L12 first collides with the door 12RF. The collision determination unit 215 calculates the point P3 as the collision position. When the collision determination unit 215 calculates the collision position between the door 12RF and the object 30w, the door opening degree control unit 216 controls the door opening degree adjustment unit 13 to limit the opening degree of the door 12RF such that the door 12RF stops right before the collision position. The line segments L1, L12, and L2 are determined to be slightly closer to the door 12RF than the actual position of the object 30w. In consideration of this, a position at which the collision can be sufficiently avoided is a position at which the opening degree of the door 12RF is limited.

In FIG. 11B, none of the line segments L1, L12, and L2 are included in the region 30A. Therefore, the collision determination unit 215 does not calculate the collision position, and the door opening degree control unit 216 does not limit the opening degree of the door 12RF. That is, the door 12RF can be fully opened.

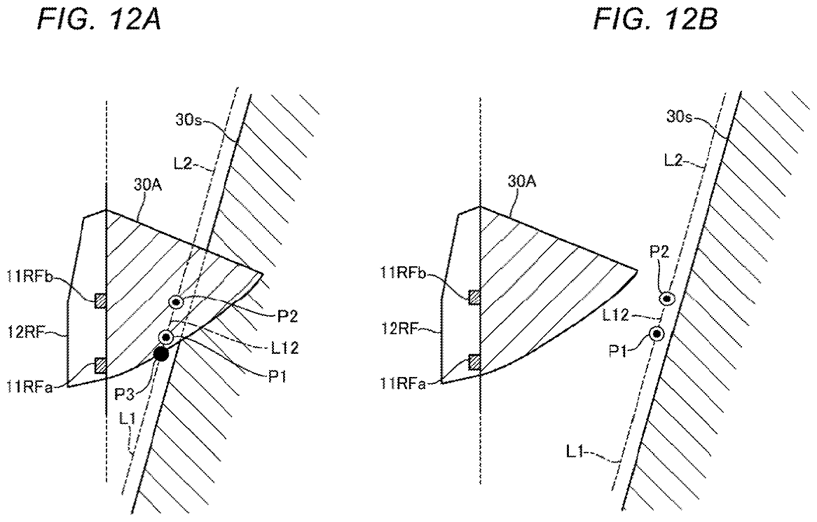

FIGS. 12A and 12B are schematic diagrams illustrating states in which a collision position between the object 30s and the door 12RF is determined by the object detection unit 20 according to the embodiment. In FIGS. 12A and 12B, it is determined that the object 30s such as a wall is present in the vicinity of the door 12RF and inclined with respect to the door 12RF.

In FIG. 12A, all of the line segments L1, L12, and L2 are included in the region 30A. In addition, when the door 12RF is opened from the fully closed state, the point P3 on the line segment L1 first collides with the door 12RF. The collision determination unit 215 calculates the point P3 as the collision position. The door opening degree control unit 216 controls the door opening degree adjustment unit 13 to limit the opening degree of the door 12RF such that the door 12RF stops right before the collision position.

In FIG. 12B, none of the line segments L1, L12, and L2 are included in the region 30A. Therefore, the collision determination unit 215 does not calculate the collision position, and the door opening degree control unit 216 does not limit the opening degree of the door 12RF.

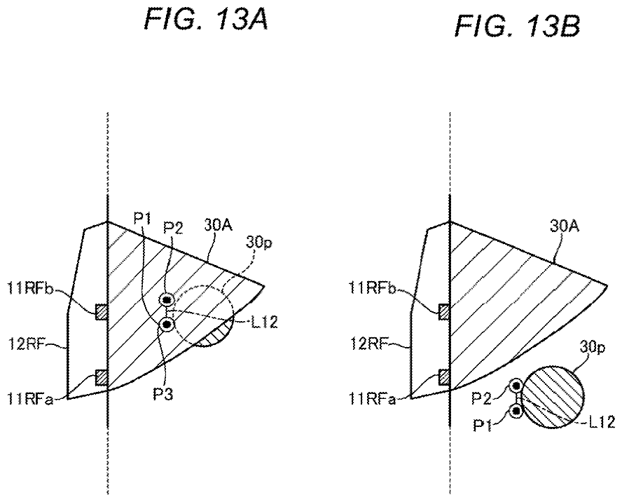

FIGS. 13A and 13B are schematic diagrams illustrating states in which a collision position between the object 30p and the door 12RF is determined by the object detection unit 20 according to the embodiment. In FIGS. 13A and 13B, it is determined that the rod-shaped object 30p such as a pole is present in the vicinity of the door 12RF. When the object 30p is a pole-shaped object, extension lines of the line segment L12 are not considered, and it is determined that the object 30p is present only on the line segment L12.

In FIG. 13A, the line segment L12 is included in the region 30A. In addition, when the door 12RF is opened from the fully closed state, the point P3 overlapping the point P1 on the line segment L12 first collides with the door 12RF. The collision determination unit 215 calculates the point P3 as the collision position. The door opening degree control unit 216 controls the door opening degree adjustment unit 13 to limit the opening degree of the door 12RF such that the door 12RF stops right before the collision position.

In FIG. 13B, the line segment L12 is not included in the region 30A. Therefore, the collision determination unit 215 does not calculate the collision position, and the door opening degree control unit 216 does not limit the opening degree of the door 12RF.

Next, a relationship between a distance from the sensor (each of the transmission and reception units 11RFa and 11RFb) to the object and a detection error will be described with reference to FIG. 14. FIG. 14 is a diagram illustrating the relationship between the distance from the sensor to the object and the detection error according to the embodiment. In FIG. 14, the transmission and reception units 11RFa and 11RFb are indicated by “transmission and reception units S1 and S2”.

The detection error occurs due to various factors. Examples of the factors include (1) to (3) as follows.

### (1) Sampling Period

A sampling period is generally short to be about tens of milliseconds, and thus an error due to the sampling period occurs regarding, for example, a reception timing or the like of a probe wave.

### (2) Threshold for Detecting Various Signals

For example, when a reflected wave is detected, it is determined that the reflected wave is detected not when a value of a detected signal starts to increase but when the value of the detected signal reaches a threshold, and thus an error in time accordingly occurs.

### (3) Temperature and Humidity of Air

A propagation speed of the probe wave in the air varies depending on a temperature and humidity of the air.

As illustrated in FIG. 14, first, it is assumed that a wall W1 is present. In this case, two detection points (estimation points) when there is no detection error include a point S1 (corresponding to the point P1 in FIGS. 5A and 5B) and a point S2 (corresponding to the point P2 in FIGS. 5A and 5B). The points S1 and S2 and points S1a to S1d and points S2a to S2d as follows, all of which correspond to the wall W1, have values of 140 or less on a horizontal axis.

The point S1a is a detection point when it is assumed that a probe wave is transmitted from the transmission and reception unit S1 and received by the transmission and reception unit S1 with a delayed predetermined error time and the probe wave is transmitted from the transmission and reception unit S1 and received by the transmission and reception unit S2 with an earlier predetermined error time.

The point S1b is a detection point when it is assumed that the probe wave is transmitted from the transmission and reception unit S1 and received by the transmission and reception unit S1 with an earlier predetermined error time and the probe wave is transmitted from the transmission and reception unit S1 and received by the transmission and reception unit S2 with a delayed predetermined error time.

The point S1c is a detection point when it is assumed that the probe wave is transmitted from the transmission and reception unit S1 and received by the transmission and reception unit S1 with a delayed predetermined error time and the probe wave is transmitted from the transmission and reception unit S1 and received by the transmission and reception unit S2 with a delayed predetermined error time.

The point S1d is a detection point when it is assumed that the probe wave is transmitted from the transmission and reception unit S1 and received by the transmission and reception unit S1 with an earlier predetermined error time and the probe wave is transmitted from the transmission and reception unit S1 and received by the transmission and reception unit S2 with an earlier predetermined error time.

The point S2a is a detection point when it is assumed that the probe wave is transmitted from the transmission and reception unit S2 and received by the transmission and reception unit S2 with a delayed predetermined error time and the probe wave is transmitted from the transmission and reception unit S2 and received by the transmission and reception unit S1 with an earlier predetermined error time.

The point S2b is a detection point when it is assumed that the probe wave is transmitted from the transmission and reception unit S2 and received by the transmission and reception unit S2 with an earlier predetermined error time and the probe wave is transmitted from the transmission and reception unit S2 and received by the transmission and reception unit S1 with a delayed predetermined error time.

The point S2c is a detection point when it is assumed that the probe wave is transmitted from the transmission and reception unit S2 and received by the transmission and reception unit S2 with a delayed predetermined error time and the probe wave is transmitted from the transmission and reception unit S2 and received by the transmission and reception unit S1 with a delayed predetermined error time.

The point S2d is a detection point when it is assumed that the probe wave is transmitted from the transmission and reception unit S2 and received by the transmission and reception unit S2 with an earlier predetermined error time and the probe wave is transmitted from the transmission and reception unit S2 and received by the transmission and reception unit S1 with an earlier predetermined error time.

The same applies to walls W2 to W5. In addition, it is assumed that magnitude of the error time required for transmission and reception of the probe wave is the same for all of the walls W1 to W5. Then, as can be seen from FIG. 14, it is considered that a longer distance from the sensor to the object (a wall or the like) leads to a smaller error of a detection position of the object. In addition, for example, in a case of the wall W3, a range of positions at which the points S1 and S2 are likely to be detected is considered to be inside a region approximately surrounded by lines L. It is considered that such a region is smaller as the distance from the sensor to the object (the wall or the like) is longer. Therefore, processing of increasing the correction amount by the position correction unit 214 as the detection position of the object is closer to positions of the transmission and reception units S1 and S2 (for example, an intermediate position thereof) is effective.

Next, a relationship between a distance from a hinge of a door to an object and a degree of influence on a door opening degree limitation due to a detection error will be described with reference to FIGS. 15A and 15B. FIGS. 15A and 15B are diagrams illustrating the relationship between the distance from the hinge of the door to the object and the degree of influence on the door opening degree limitation due to the detection error according to the embodiment.

In FIGS. 15A and 15B, a door D (door 12), sensors X1 and X2 (the transmission and reception units 11RFa and 11RFb), and a hinge H are illustrated. In FIG. 15A, one of points Y11 and Y12 is a true value (a detection position without error), and the other is a detection position with an error. Due to this error, an error of a length H1 occurs in a portion of a trajectory E of an end portion of the door D when the door D is opened and closed.

On the other hand, in FIG. 15B, points Y21 and Y22 are located farther from the hinge H than the points Y11 and Y12 in FIG. 15A. A distance between the point Y21 and the point Y22 is equal to a distance between the points Y11 and Y12. In this case, due to this error, an error of a length H2 occurs in the portion of the trajectory E of the end portion of the door D when the door D is opened and closed.

As can be seen from FIGS. 15A and 15B, the length H1 is larger than the length H2. Therefore, processing of increasing the correction amount by the position correction unit 214 as the detection position of the object is closer to a position of the hinge H of the door D is effective. In other words, for example, safety when the detection position of the object is used for subsequent door opening degree control is further improved accordingly.

Next, FIGS. 16A and 16B are diagrams illustrating an example of object detection according to the embodiment. In FIG. 16A, it is assumed that two detection points are points Y31 and Y32 with respect to a position of a wall W, and a separation distance therebetween is equal to or greater than the separation distance threshold. In this case, it is determined that the object has a wall shape, and the door opening degree is limited with reference to, for example, a point E11 obtained by correcting a position of an intersection point E12 between extension lines of the points Y31 and Y32 and the trajectory E of the end portion of the door D when the door D is opened and closed. Accordingly, a collision between the door D and the wall W can be avoided.

On the other hand, in FIG. 16B, it is assumed that two detection points are points Y41 and Y42 with respect to the position of the wall W, and a separation distance therebetween is less than the separation distance threshold. In this case, it is determined that the object has a pole shape, and the door opening degree is limited with reference to the points Y41 and Y42 instead of an intersection point E22 between extension lines of the points Y41 and Y42 and the trajectory E of the end portion of the door D when the door D is opened and closed. However, in this case, the object is actually the wall W, and the door D may collide with the wall W.

In such a case, even though the object determination unit 212 determines that the object has a pole shape, the reflection intensity may exceed the predetermined reflection intensity threshold when the object is actually a wall. Therefore, processing of setting the correction amount, by the position correction unit 214, to be larger when the object determination unit 212 determines that the object has a pole shape and the reflection intensity calculated by the reflection intensity processing unit 213 exceeds the predetermined reflection intensity threshold than when the reflection intensity does not exceed the predetermined reflection intensity threshold is effective. A point E21 is a true value of the position of the object (the wall W) in the portion of the trajectory E of the end portion of the door D when the door D is opened and closed.

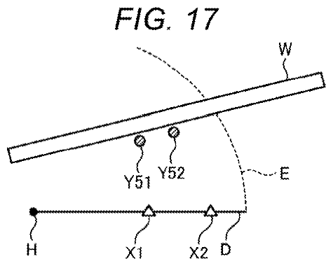

FIG. 17 is a diagram illustrating an example of the object detection according to the embodiment. The object is the wall W, and the wall W is inclined to approach a hinge H side of the door D as compared with when the wall W is parallel to the door D. In this case, Y51 and Y52 as two detection points are detected to be closer to the hinge H of the door D as compared with when the wall W is parallel to the door D. Therefore, even when coordinates of Y51 and Y52 as the two detection points are not calculated, it is possible to estimate that Y51 and Y52 as the two detection points are detected to be closer to the hinge H of the door D as compared with when the wall W is parallel to the door D simply by recognizing a relative positional relationship (an angle of a line connecting the two points with respect to a reference line) between Y51 and Y52. Then, the correction amount can be increased by the position correction unit 214.

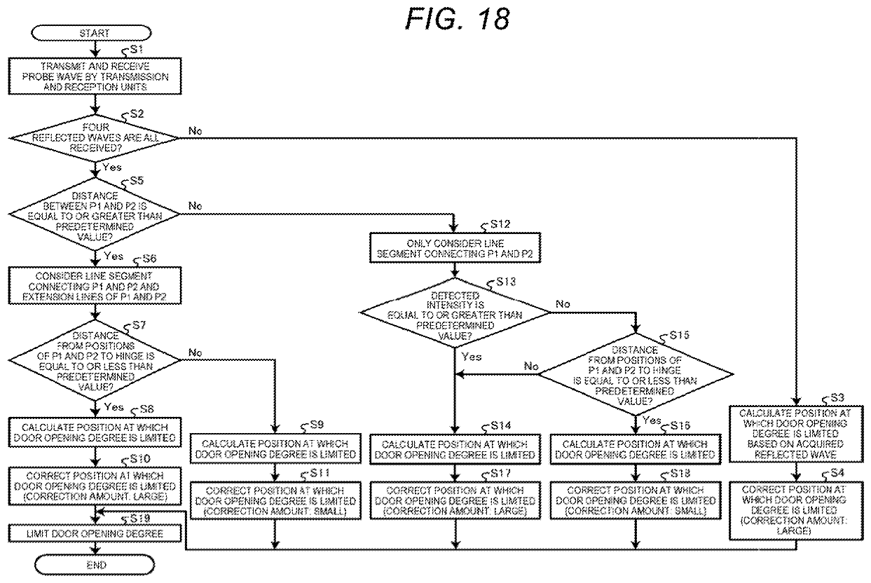

Next, a procedure for object detection processing performed by the object detection apparatus 1 will be described. FIG. 18 is a flowchart illustrating the object detection processing performed by the object detection apparatus 1 according to the embodiment. In the following example, a detected object is present in a region based on a trajectory during opening and closing of a door.

First, in step S1, among the transmission and reception units 11 of the object detection apparatus 1, the transmission and reception units 11 provided on the same door 12 alternately repeat a period in which each of the transmission and reception units 11 transmits and receives a probe wave and a period in which one of the transmission and reception units 11 only receives a probe wave.

Next, in step S2, the processing unit 21 determines whether four reflected waves are all received. When it is determined to be Yes, the processing proceeds to step S5, and when it is determined to be No, the processing proceeds to step S3.

In step S3, the object determination unit 212 calculates a position (a position of the object) at which a door opening degree is limited based on the acquired reflected wave.

Next, in step S4, the position correction unit 214 corrects the position with a larger correction amount than when the four reflected waves are all received.

In step S5, the object determination unit 212 determines whether the separation distance between the points P1 and P2 (see FIGS. 5A and 5B and the like) is equal to or greater than the predetermined value. When it is determined to be Yes, the processing proceeds to step S6, and when it is determined to be No, the processing proceeds to step S12.

In step S6, the object determination unit 212 performs the following processing in consideration of a line segment connecting the points P1 and P2 and extension lines of the points P1 and P2.

Next, in step S7, the position correction unit 214 determines whether a distance from positions of the points P1 and P2 (for example, an intermediate position thereof) to a hinge of the door is equal to or less than the predetermined value. When it is determined to be Yes, the processing proceeds to step S8, and when it is determined to be No, the processing proceeds to step S9.

In step S8, the object determination unit 212 calculates the position (the position of the object) at which the door opening degree is limited.

Next, in step S10, the position correction unit 214 corrects the position with a larger correction amount than in a case of step S11.

In step S9, the object determination unit 212 calculates the position (the position of the object) at which the door opening degree is limited.

Next, in step S11, the position correction unit 214 corrects the position with a smaller correction amount than in the case of step S10.

In step S12, the object determination unit 212 performs the following processing only considering the line segment connecting the points P1 and P2.

In step S13, the reflection intensity processing unit 213 determines whether a reflection intensity is equal to or greater than the predetermined value (the predetermined reflection intensity threshold). When it is determined to be Yes, the processing proceeds to step S14, and when it is determined to be No, the processing proceeds to step S15.

In step S14, the object determination unit 212 calculates the position (the position of the object) at which the door opening degree is limited.

Next, in step S17, the position correction unit 214 corrects the position with a larger correction amount than in a case of step S18.

In step S15, the position correction unit 214 determines whether the distance from the positions of the points P1 and P2 (for example, the intermediate position thereof) to the hinge of the door is equal to or less than the predetermined value. When it is determined to be Yes, the processing proceeds to step S16, and when it is determined to be No, the processing proceeds to step S14.

In step S16, the object determination unit 212 calculates the position (the position of the object) at which the door opening degree is limited.

Next, in step S18, the position correction unit 214 corrects the position with a smaller correction amount than in the case of step S17.

After steps S10, S11, S17, S18, and S4, in step S19, the door opening degree control unit 216 controls the door opening degree adjustment unit 13 to limit the opening degree of the door 12 such that the door 12 stops right before a collision position based on the collision position between the door 12 and the object calculated by the collision determination unit 215 using the corrected position.

In this manner, according to the object detection apparatus 1 of the embodiment, accuracy of a determination result related to object detection can be improved by adjusting the correction amount of the position of the object according to the detection position of the object. Therefore, for example, it is possible not only to avoid a collision between the door and the object, but also to avoid a situation in which a door opening operation is stopped at a time point at which the door and the object are still far from each other.

In addition, it is possible to perform an appropriate correction according to detection characteristics that a detection error is smaller as a distance from a sensor (each of the first transmission and reception unit and the second transmission and reception unit) to the object is longer.

Further, the correction amount is set to be larger as the detection position of the object is closer to a position of the hinge, so that the safety when the detection position of the object is used for subsequent door opening degree control is further improved.

Even when it is determined that the object has a pole shape, the object may also have a wall shape when the reflection intensity exceeds the predetermined reflection intensity threshold. The correction amount is made large based on this fact so that the safety when the detection position of the object is used for the subsequent door opening degree control is further improved.

In addition, it is possible to perform an appropriate position correction according to a possibility that the object does not have a simple shape even if none of the four reflected waves are received. For example, when the object has a complicated shape, such as a bicycle, the collision between the door and the object can be more reliably avoided by correcting the position with a larger correction amount, and the safety is further improved.

Although the embodiment according to this disclosure has been described, the above embodiment and modifications are merely examples and are not intended to limit the scope of this disclosure. The embodiment described above and modifications can be implemented in various other forms, and various omissions, substitutions, combinations, and changes can be made without departing from the spirit of this disclosure. In addition, configurations and shapes of the embodiment and the modifications can be partially replaced.

For example, in the above embodiment, the object detection unit 20 includes, for example, one ECU, but this disclosure is not limited thereto. The object detection unit 20 may include a plurality of ECUs. At this time, one ECU may function as a part of the object detection unit 20, and other ECUs may function as other parts of the object detection unit 20.

In the above embodiment, each of the transmission and reception units 11RFa and 11RFb alternately repeats the period in which the transmission and reception unit 11 transmits and receives the probe wave and the period in which the transmission and reception unit 11 only receives the probe wave, but this disclosure is not limited thereto. In the above configuration, the probe waves T11, T12, T21, and T22 can be detected at least once, and each of the transmission and reception units 11RFa and 11RFb may sequentially detect these probe waves T11, T12, T21, and T22 once. Alternatively, after the transmission and reception unit 11RFa continuously repeats transmission and reception a plurality of times and receives the probe waves T11 and T12 a plurality of times in succession, the transmission and reception unit 11RFb may continuously repeat transmission and reception a plurality of times and receive the probe waves T21 and T22 a plurality of times in succession. Alternatively, after the transmission and reception unit 11RFa continuously repeats transmission and reception a plurality of times and receives the probe waves T11 and T12 a plurality of times in succession, the transmission and reception unit 11RFb may perform transmission and reception only once and receive the probe waves T21 and T22 only once. Alternatively, vice versa may be possible.

In the above embodiment, two transmission and reception units 11 are provided on one door 12, but this disclosure is not limited thereto. For example, three or more transmission and reception units may be provided for one door. By increasing the number of transmission and reception units, it is possible to detect an object in a wider range with higher accuracy.

In the above embodiment, the plurality of transmission and reception units 11 are provided in the vehicle 10, but this disclosure is not limited thereto. The transmission and reception units can be suitably used for, for example, all mobile objects whose surrounding environment changes constantly due to movement.

According to an aspect of this disclosure, an object detection apparatus includes, for example, a first transmission and reception unit and a second transmission and reception unit which are away from each other by a predetermined distance in a horizontal direction and transmit a probe wave and receive the probe wave reflected by an object, and a processing unit configured to calculate a position of the object based on a reception result received by the first transmission and reception unit and a reception result received by the second transmission and reception unit. The processing unit includes: a distance processing unit configured to calculate a first point based on a reception result received by the first transmission and reception unit and a reception result received by the second transmission and reception unit when the first transmission and reception unit transmits the probe wave, calculate a second point based on a reception result received by the first transmission and reception unit and a reception result received by the second transmission and reception unit when the second transmission and reception unit transmits the probe wave, and calculate a separation distance between the first point and the second point; a position calculation unit configured to calculate the position of the object based on the first point and the second point; and a position correction unit configured to correct the position of the object with a correction amount corresponding to the calculated position of the object to correct an error that occurs when the position of the object is calculated.

With this configuration, accuracy of a determination result related to object detection can be improved by adjusting the correction amount of the position of the object corresponding to a detection position of the object.

In the object detection apparatus, for example, the position correction unit sets the correction amount to be larger as the position at which the object is detected is closer to positions of the first transmission and reception unit and the second transmission and reception unit.

With this configuration, it is possible to perform an appropriate correction according to detection characteristics that a detection error is smaller as a distance from a sensor (each of the first transmission and reception unit and the second transmission and reception unit) to the object is longer.

In the object detection apparatus, for example, the first transmission and reception unit is provided on one of a hinge side and an opening and closing end side of a door that is opened and closed by rotating about a hinge as a shaft, and the second transmission and reception unit is provided on the other one of the hinge side and the opening and closing end side of the door. The position correction unit sets the correction amount to be larger as the position at which the object is detected is closer to a position of the hinge.

With this configuration, safety when the detection position of the object is used for subsequent door opening degree control is further improved.

In the object detection apparatus, for example, the processing unit further includes a shape determination unit configured to determine whether the object has a wall shape or a pole shape according to the separation distance, and a reflection intensity processing unit configured to calculate a reflection intensity representing an intensity of the probe wave received by each of the first transmission and reception unit and the second transmission and reception unit. The position correction unit sets the correction amount to be larger when the shape determination unit determines that the object has a pole shape and the reflection intensity calculated by the reflection intensity processing unit exceeds a predetermined reflection intensity threshold than when the reflection intensity does not exceed the predetermined reflection intensity threshold.

With this configuration, even when it is determined that the object has a pole shape, the object may also have a wall shape when the reflection intensity exceeds the predetermined reflection intensity threshold. The correction amount is made large based on this fact, and thus the safety when the detection position of the object is used for the subsequent door opening degree control is further improved.

In the object detection apparatus, for example, when at least one of probe waves transmitted by the first transmission and reception unit and the second transmission and reception unit is not received by the first transmission and reception unit or the second transmission and reception unit, the position correction unit sets the correction amount to be larger than when all of the probe waves are received.

With this configuration, it is possible to perform an appropriate correction according to a possibility that the object does not have a simple shape even if none of four reflected waves are received.

In the object detection apparatus, for example, the processing unit further includes a collision determination unit configured to determine whether the object is present in a region surrounded by a fully closed position of the door, a fully opened position of the door, and a trajectory during opening and closing of the door, and calculate a collision position between the object and the door when the object is present in the region.

With this configuration, the collision position between the object and the door can be used for various subsequent processing.

In the object detection apparatus, for example, the door is provided in a vehicle, and the processing unit further includes a door opening degree control unit configured to limit an opening degree of the door based on the collision position calculated by the collision determination unit.

With this configuration, it is possible to appropriately limit the opening degree of the door based on a highly accurate collision position.

According to another aspect of this disclosure, an object detection method uses, for example, an object detection apparatus including a first transmission and reception unit and a second transmission and reception unit which are away from each other by a predetermined distance in a horizontal direction and transmit a probe wave and receive the probe wave reflected by an object. The method includes: a distance processing step of calculating a first point based on a reception result received by the first transmission and reception unit and a reception result received by the second transmission and reception unit when the first transmission and reception unit transmits the probe wave, calculating a second point based on a reception result received by the first transmission and reception unit and a reception result received by the second transmission and reception unit when the second transmission and reception unit transmits the probe wave, and calculating a separation distance between the first point and the second point; a position calculation step of calculating a position of the object based on the first point and the second point; and a position correction step of correcting the position of the object with a correction amount corresponding to the calculated position of the object to correct an error that occurs when the position of the object is calculated.

With this configuration, accuracy of a determination result related to object detection can be improved by adjusting the correction amount of the position of the object corresponding to a detection position of the object.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. An object detection apparatus comprising:
a first transmission and reception unit and a second transmission and reception unit which are away from each other by a predetermined distance in a horizontal direction and transmit a probe wave and receive the probe wave reflected by an object; and
a processing unit configured to calculate a position of the object based on a reception result received by the first transmission and reception unit and a reception result received by the second transmission and reception unit, wherein
the processing unit includes
a distance processing unit configured to calculate a first point based on a reception result received by the first transmission and reception unit and a reception result received by the second transmission and reception unit when the first transmission and reception unit transmits the probe wave, calculate a second point based on a reception result received by the first transmission and reception unit and a reception result received by the second transmission and reception unit when the second transmission and reception unit transmits the probe wave, and calculate a separation distance between the first point and the second point,
a position calculation unit configured to calculate the position of the object based on the first point and the second point, and
a position correction unit configured to correct the position of the object with a correction amount corresponding to the calculated position of the object to correct an error that occurs when the position of the object is calculated.

2. The object detection apparatus according to claim 1, wherein
the position correction unit sets the correction amount to be larger as the position at which the object is detected is closer to positions of the first transmission and reception unit and the second transmission and reception unit.

3. The object detection apparatus according to claim 1, wherein
the first transmission and reception unit is provided on one of a hinge side and an opening and closing end side of a door that is opened and closed by rotating about a hinge as a shaft,
the second transmission and reception unit is provided on the other one of the hinge side and the opening and closing end side of the door, and
the position correction unit sets the correction amount to be larger as the position at which the object is detected is closer to a position of the hinge.

4. The object detection apparatus according to claim 1, wherein
the processing unit further includes a shape determination unit configured to determine whether the object has a wall shape or a pole shape according to the separation distance, and a reflection intensity processing unit configured to calculate a reflection intensity representing an intensity of the probe wave received by each of the first transmission and reception unit and the second transmission and reception unit, and
the position correction unit sets the correction amount to be larger when the shape determination unit determines that the object has a pole shape and the reflection intensity calculated by the reflection intensity processing unit exceeds a predetermined reflection intensity threshold than when the reflection intensity does not exceed the predetermined reflection intensity threshold.

5. The object detection apparatus according to claim 1, wherein
when at least one of probe waves transmitted by the first transmission and reception unit and the second transmission and reception unit is not received by the first transmission and reception unit or the second transmission and reception unit, the position correction unit sets the correction amount to be larger than when all of the probe waves are received.

6. The object detection apparatus according to claim 3, wherein
the processing unit further includes a collision determination unit configured to determine whether the object is present in a region surrounded by a fully closed position of the door, a fully opened position of the door, and a trajectory during opening and closing of the door, and calculate a collision position between the object and the door when the object is present in the region.

7. The object detection apparatus according to claim 6, wherein
the door is provided in a vehicle, and
the processing unit further includes a door opening degree control unit configured to limit an opening degree of the door based on the collision position calculated by the collision determination unit.

8. An object detection method using an object detection apparatus including a first transmission and reception unit and a second transmission and reception unit which are away from each other by a predetermined distance in a horizontal direction and transmit a probe wave and receive the probe wave reflected by an object, the object detection method comprising:
a distance processing step of calculating a first point based on a reception result received by the first transmission and reception unit and a reception result received by the second transmission and reception unit when the first transmission and reception unit transmits the probe wave, calculating a second point based on a reception result received by the first transmission and reception unit and a reception result received by the second transmission and reception unit when the second transmission and reception unit transmits the probe wave, and calculating a separation distance between the first point and the second point;
a position calculation step of calculating a position of the object based on the first point and the second point; and
a position correction step of correcting the position of the object with a correction amount corresponding to the calculated position of the object to correct an error that occurs when the position of the object is calculated.
